(19) United States
(12) Patent Application Publication
(10) Pub. No.: US 2002/0056065 A1
(43) Pub. Date: May 9, 2002

(54) Turbo encoding and decoding method and apparatus

(75) Inventors: Hyunho Jung, Busan (KR); Sin-Chong Park, Daejeon (KR)

Correspondence Address: SHAHAN ISLAM, ESQ., ROSENMAN & COLIN LLP, 575 Madison Avenue, New York, NY, 10022-2585, US

(73) Assignee: Information and Communications University Educational Foundation, Seoul (KR)

(21) Appl. No.: 09/792,264

(22) Filed: Feb. 23, 2001

(30) Foreign Application Priority Data
Nov. 8, 2000 (KR) 2000-066053

(51) Int. Cl. G06F 11/08

(52) U.S. Cl. 714/758; 714/800

(57) ABSTRACT

A turbo encoding and decoding method and apparatus iteratively performs its decoding process as many times as the number of decoding times adaptively determined according to an amount of errors caused in a transmitted information bit stream so as to correct the errors, wherein the amount of errors is detected by checking a state of parity bits inserted into information bits during a turbo encoding process. The turbo encoder first inserts the parity bits into the information bits and encodes the parity bit inserted information bits to thereby produce the information bit stream to be transmitted. Then, in order to reconstruct the information bits based on the transmitted information bit stream, the turbo decoder recursively decodes the information bit stream as many times as the adaptively determined number of decoding times to thereby output a decoded information bit stream, the number of decoding times being determined by checking the parity bits included in the decoded information bit stream, and produces decoded information bits by deleting the parity bits from the decoded information bit stream after recursively performing the decoding process as many times as the adaptively determined number of decoding times.

### FIELD OF THE INVENTION

The present invention relates to channel encoding and decoding systems; and, more particularly, to a turbo encoding and decoding method and apparatus for iteratively performing its decoding process, wherein the number of iterative decoding times is adaptively determined based on the amount of errors caused in a transmitted information bit stream, the amount of errors being detected by checking a state of parity bits inserted into the information bit stream during a turbo encoding process.

### BACKGROUND OF THE INVENTION

In next generation mobile communication systems, there are required effective channel coding and modulation schemes in order to perform a reliable transmission of very high bit rate multimedia data. International Mobile Telecommunications-2000 (IMT-2000) is the next generation mobile system that will unify regulations of diverse communication systems being used in many countries in the world to thereby allow global or international roaming in different IMT-2000 operational environments so that a mobile user can accomplish anywhere, anytime communication through the use of one terminal.

That is, as a strategic priority of International Telecommunication Union (ITU), IMT-2000 provides framework for worldwide wireless access by linking the diverse communication systems of terrestrial and/or satellite based networks.

Turbo coding is one of the most exciting and potentially important developments in coding theory in recent years. It was first introduced in 1993 and offers near idealistic, Shannon-limit error correction performance. This capability has led the turbo coding to become an emerging coding technique for the next generation wireless communication protocol, such as Wideband CDMA (W-CDMA) and subsequent 3rd Generation Partnership Project (3GPP) for IMT-2000.

The turbo codes have performance depending on the number of recursive decoding times and the size of an interleaver. That is, as the size of the interleaver and the number of recursive decoding times increase, the performance of the turbo encoding and decoding is improved.

Referring to FIG. 1, there is illustrated a block diagram of a conventional turbo encoder which is composed of two or more identical recursive systematic convolutional (RSC) encoders separated by an interleaver. That is, the turbo encoder comprises a first and a second encoding units 11 and 13 connected to each other in parallel, an interleaver 15 attached to an input terminal of the second encoding unit 13, and a multiplexer (MUX) 17.

Information bits are provided into the multiplexer 17, the first encoding unit 11 and the interleaver 15 in parallel on a block-by-block basis, each block including a predetermined number of information bits.

The first encoding unit 11 encodes information bits of the inputted information bit block according to its original bit sequence and outputs a first encoded parity part to be coupled to the multiplexer 17.

The interleaver 15 reorders a bit sequence of the inputted information bit block and provides the reordered information bit block to the second encoding unit 13 so as to uncorrelate the inputs of the two encoding units 11 and 13. That is, the interleaver 15 translates uncorrectable burst errors into correctable random errors like a wellknown convolutional interleaver.

For example, if the information bits incorrectly decoded due to the burst errors in a first decoding unit of a turbo decoder are fed to a second decoding unit, decoded information bits generated from the second decoding unit are also incorrect. Therefore, when a recursive decoding process is performed, the errors included in the decoded information bits continuously affect the recursive decoding process and, as a result, the decoding process cannot be successfully implemented.

Accordingly, in order to avoid the error feedback by effectively converting correlated information to uncorrelated information, it is very useful to employ an interleaver capable of spreading the burst errors.

The reordered information bit block outputted from the interleaver 15 is coupled to the second encoding unit 13 that encodes the reordered information bit block to thereby produce a second encoded parity part to the multiplexer 17.

The multiplexer 17 multiplexes the information bit block and the first and the second encoded parity parts provided thereto and outputs an encoded information bit stream to be transmitted through a transmission channel.

In FIG. 2, there is shown a block diagram of a conventional turbo decoder that decodes the encoded information bit stream transmitted via the transmission channel from the turbo encoder. As described in the drawing, the decoder comprises a demultiplexer (DEMUX) 21, a first and a second decoding units 23 and 25, an interleaver 27 and a deinterleaver 29.

The demultiplexer 21 demultiplexes the encoded information bit stream on a block-by-block basis to thereby generate an information part, a first parity part and a second parity part for each information bit block. The information part and the first parity part, and the second parity part are coupled to the first and the second decoding units 23 and 25, respectively.

The first and the second decoding units 23 and 25 employ a MAP (Maximum A Posteriori) decoding algorithm so as to perform recursive computational processes and show a feature substantially approximated to Shannon-Limit with respect to a BER (bit error rate) by increasing the number of recursive decoding times.

More specifically, in order to improve the decoding reliability, in a recursive decoding process, the first and the second decoding units 23 and 25 receive extrinsic bits generated from the deinterleaver 29 and the interleaver 27, respectively, in addition to the information part and the first parity part, and the second parity part.

That is, the first decoding unit 23 performs the MAP decoding algorithm based on the information part and the first parity part coupled from the demultiplexer 21, and the extrinsic bits provided from the deinterleaver 29, thereby generating first decoded information bits.

Then, the interleaver 27 interleaves the first decoded information bits in the same manner as used in the turbo encoder to thereby provide the second decoding unit 25 with first extrinsic bits.

On the other hand, the second decoding unit 25 performs the MAP decoding algorithm by using the second parity part, which is demultiplexed from the encoded information bit stream at the demultiplexer 21, and the first extrinsic bits from the interleaver 27, thereby producing second decoded information bits to the deinterleaver 29, which deinterleaves the second decoded information bits and then provides the deinterleaved bits to the first decoding unit 23 as second extrinsic bits.

Once the second extrinsic bits are provided thereto, the first decoding unit 23 repeatedly performs the MAP decoding algorithm based on the information part, the first parity part and the second extrinsic bits.

The above recursive decoding process for a given information bit block performed by the first and the second decoding units 23 and 25 is repeated as many times as the preset number of decoding times. After the decoding process is iterated as many times as the preset number of decoding times, the deinterleaved information bits retrieved from the deinterleaver 29 are outputted as decoded information bits for the given information bit block, and the first and the second decoding units 23 and 25 perform the MAP decoding algorithm for a next information bit block.

As described above, the turbo decoder repeats the decoding process so as to improve its BER performance in proportion to the number of recursive decoding times. Therefore, it is advantageous for the BER performance to increase the number of recursive decoding times as much as possible. Since, however, the decoding time and power consumption are also increased with an increase in the number of decoding times, it is desirable to determine an appropriate or optimal number of decoding times.

Accordingly, in general, the conventional turbo decoder is constructed to repeatedly fulfill the decoding process for the encoded information bit stream as many times as the predetermined number of decoding times. However, in the decoding process, each turbo code has a different rate of error incidence according to features of the turbo code and transmission channel. As a result, in case of using the conventional turbo decoder which recursively implements the decoding process as many times as the predetermined number of decoding times for all turbo codes, it is impossible to perfectly reconstruct a turbo code having a substantial amount of errors therein unless the predetermined number is set very high, which in turn will make an unnecessary decoding iteration for a turbo code whose error occurrence is low, thereby causing an unnecessarily long decoding time and an excessive power consumption.

### SUMMARY OF THE INVENTION

It is, therefore, a primary object of the present invention to provide a turbo encoding and decoding method and apparatus for iteratively performing a decoding process for an information bit stream, wherein the number of iterative decoding times is adaptively determined depending on an amount of errors caused in the information bit stream during a data transmission, the amount of errors being detected by checking a state of parity bits inserted into the information bit stream during the turbo encoding process.

In accordance with one aspect of the present invention, there is provided a method for communicating information bits, which comprises the steps of:

(a) inserting parity bits into the information bits to thereby output parity bit inserted information bits;

(b) encoding the parity bit inserted information bits to thereby produce an information bit stream to be transmitted;

(c) receiving the information bit stream;

(d) decoding the received information bit stream to thereby produce a decoded information bit stream;

(e) calculating parity bits corresponding to the information bit stream;

(f) detecting parity bits included in the decoded information bit stream;

(g) comparing the calculated parity bits with the detected parity bits included in the decoded information bit stream;

(h) if the detected parity bits are not identical to the calculated parity bits, repeating the steps (d), (f) and (g) as many times as the predetermined number of decoding times based on the decoded information bit stream; and

(i) if the detected parity bits are identical to the calculated parity bits, deleting the detected parity bits from the decoded information bit stream to thereby provide decoded information bits.

In accordance with another aspect of the present invention, there is provided an apparatus for communicating information bits, which comprises:

a turbo encoder for inserting parity bits into the information bits and encoding the parity bit inserted information bits to thereby produce an information bit stream to be transmitted; and

a turbo decoder for recursively performing a decoding process for the information bit stream as many time as an adaptively determined number of decoding times to thereby output a decoded information bit stream, detecting parity bits included in the decoded information bit stream, and producing decoded information bits by deleting the detected parity bits from the decoded information bit stream after recursively performing the decoding process as many times as the adaptively determined number of decoding times, wherein the number of decoding times is determined by checking a state of the detected parity bits included in the decoded information bit stream.

### BRIEF DESCRIPTION OF THE DRAWINGS

The above and other objects and features of the present invention will become apparent from the following description of preferred embodiments given in conjunction with the accompanying drawings, in which:

FIG. 1 shows a block diagram of a conventional turbo encoder;

FIG. 2 provides a block diagram of a conventional turbo decoder;

FIG. 3 illustrates a block diagram of a turbo encoder in accordance with the present invention; and

FIG. 4 describes a block diagram of a turbo decoder in accordance with the present invention.

### DETAILED DESCRIPTION OF THE PREFERRED EMBODIMENTS

While referring to the drawings, the preferred embodiments of the present invention will now be explained in detail. Hereinbelow, same reference numerals are used to designate the same or equivalent parts throughout the description.

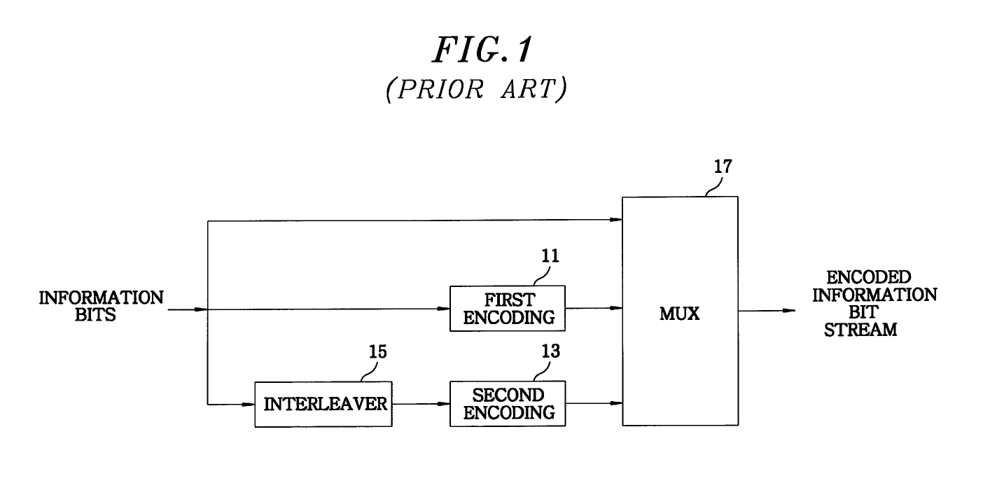

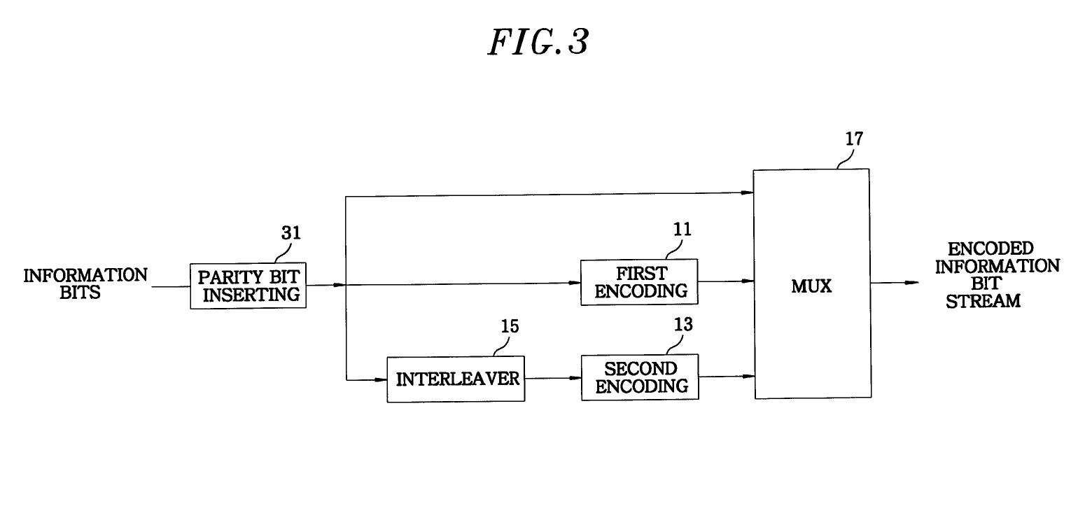

Referring to FIG. 3, there is shown a structure of a turbo encoder in accordance with the present invention. The inventive turbo encoder further comprises a parity bit inserting unit 31 in addition to units of the conventional turbo encoder described in FIG. 1, a first encoding unit 11, a second encoding unit 13, an interleaver 15 and a multiplexer 17.

If information bits are coupled thereto on a block-by-block basis, the parity bit inserting unit 31 periodically inserts an even or odd number of parity bits into information bits of information bit blocks, wherein each information bit block contains a predetermined number of information bits.

The information bit block having the parity bits therein is provided to the multiplexer 17, the first encoding unit 11 and the interleaver 15 in parallel.

The information bit block fed to the first encoding unit 11 is encoded and provided to the multiplexer 17.

Meanwhile, the interleaver 15 mixes the information bits of the information bit block coupled thereto and, in turn, the second encoding unit 13 encodes the mixed information bit block and provides the multiplexer 17 with the encoded information bit block.

Like the conventional turbo encoder explained with reference to FIG. 1, the multiplexer 17 produces an encoded information bit stream by multiplexing the information bit blocks, provided from the parity bit inserting unit 31, the first encoding unit 11 and the second encoding unit 13, respectively, on a bit-by-bit basis. The encoded information bit stream is delivered to a receiving end through a transmission channel.

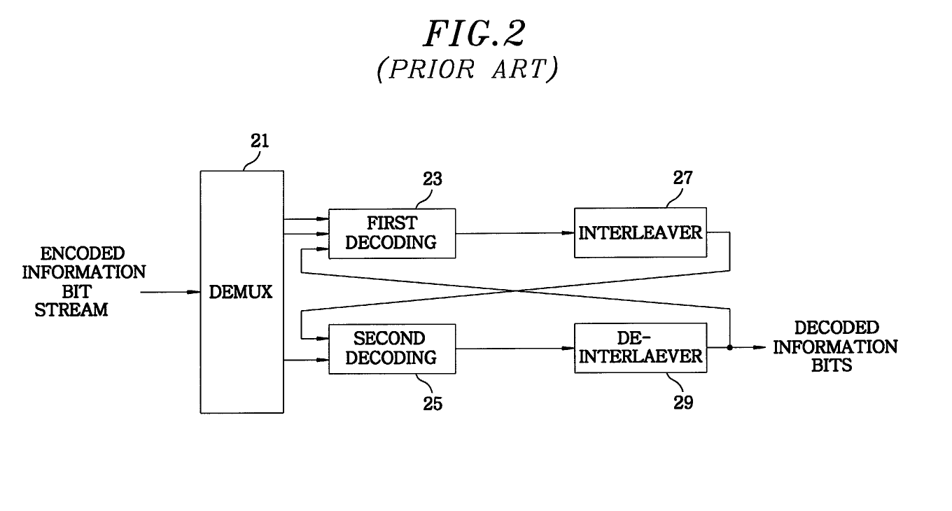

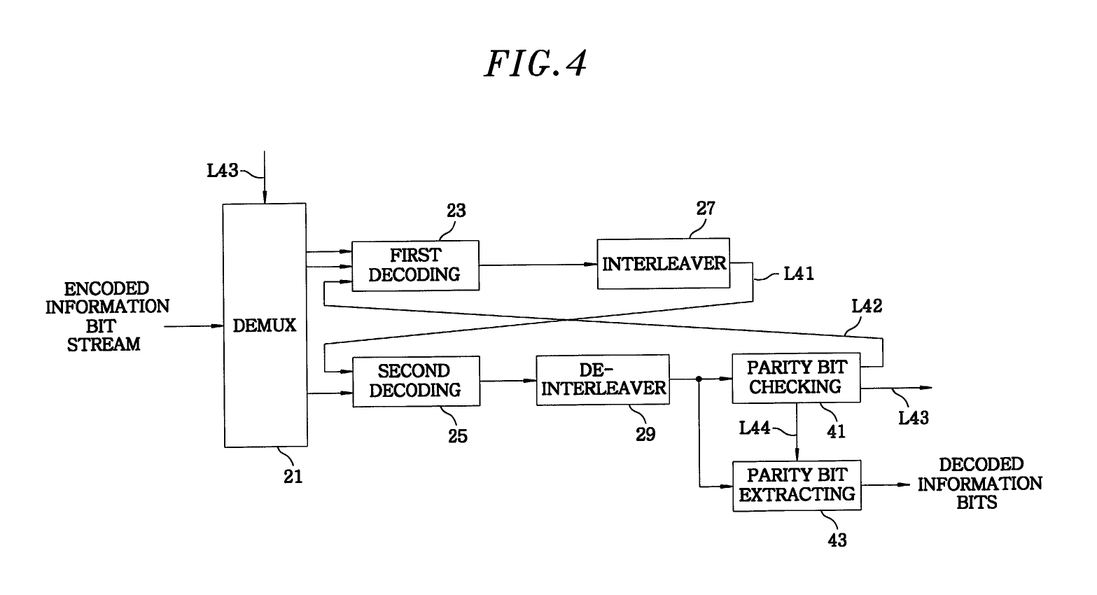

In FIG. 4, there is illustrated a block diagram of a turbo decoder in accordance with the present invention. In addition to a demultiplexer 21, a first decoding unit 23, a second decoding unit 25, an interleaver 27 and a deinterleaver 29 of the conventional turbo decoder shown in FIG. 2, the inventive turbo decoder further comprises a parity bit checking unit 41 and a parity bit extracting unit 43.

The demultiplexer 21 first demultiplexes the encoded information bit stream transmitted from the turbo encoder so as to produce an information part, a first parity part and a second parity part for each information bit block.

In a decoding process for a given information bit block, the first decoding unit 23 first performs the MAP decoding process based on the information part and the first parity part for the given information bit block supplied from the demultiplexer 21 to thereby generate first decoded information bits. The first decoded information bits are interleaved at the interleaver 27 to be provided to the second decoding unit 25 as first extrinsic bits via a line L41.

The second decoding unit 25 also performs the MAP decoding process based on the second parity part for the given information bit block coupled from the demultiplexer 21 and the first extrinsic bits delivered via the line L41 from the interleaver 27 and provides second decoded information bits to the deinterleaver 29.

If the deinterleaver 29 deinterleaves the second decoded information bits and the deinterleaved information bits are inputted to the parity bit checking unit 41 and the parity bit extracting unit 43, the first decoding process for the given information bit block is completed.

Once the deinterleaved information bits are inputted thereto, in order to determine whether or not the decoding process will be repeated for the given information bit block, the parity bit checking unit 41 first calculates an even or odd number of parity bits for the given information bit block and then compares the calculated parity bits with decoded parity bits included in the deinterleaved information bits.

As results of the above comparison process, if the calculated parity bits are identical to the decoded parity bits, it is determined that there is no detected error in the decoded information bits and the decoding process for the given information bit block is terminated. At this time, the parity bit checking unit 41 reports via a line L43 the termination of the decoding process for the given information bit block to the demultiplexer 21 which, in turn, provides the first and the second decoding units 23 and 25 with an information part and a first and a second parity parts for a next information bit block.

On the other hand, if the calculated parity bits are different from the decoded parity bits, the parity bit checking unit 41 transfers the deinterleaved information bits provided from the deinterleaver 29 to the first decoding unit 23 via a line L42 as second extrinsic bits to thereby repeat the decoding process for the given information bit block.

This decoding process for the given information bit block is recursively performed when the parity bit checking unit 41 determines that there are errors in the deinterleaved information bits through the parity checking process as described above. However, although there are errors in the deinterleaved information bits, it cannot be permitted to indefinitely repeat the decoding procedure for the given information bit block and thus a maximal number of decoding times for one information bit block is set.

Accordingly, if there are still found errors in the deinterleaved information bits after the decoding process for the given information bit block is repeated as many times as the maximal number of decoding times, the parity bit checking unit 41 indicates there are errors in the given information bit block with the approximated location of the errors on a display unit(not shown) and produces a first and second control signal to the demultiplexer 21 and the parity bit extracting unit 43 via lines L43 and L44, respectively.

In response to the first control signal transmitted through the line L43, the demultiplexer 21 transfers an information part, a first parity part and a second parity part for a next information bit block to the first and the second decoding units 23 and 25.

Meanwhile, when the second control signal is provided thereto from the parity bit checking unit 41 via the line L44, the parity bit extracting unit 43 eliminates the decoded parity bits within the deinterleaved information bits provided from the deinterleaver 29 to thereby output decoded or reconstructed information bits for the given information bit block.

As can be seen above, by using the inventive turbo encoder and decoder instead of the conventional turbo encoder and decoder in which the number of decoding times for one information bit block is fixed, the present invention can perform an adaptive decoding process whose iterative decoding times are automatically decided by determining whether or not there exist errors occurred in the decoded information bit blocks based on parity bits inserted into the information bit block in an encoding process for the information bit block. As a result, the present invention can reduce the power consumption required in the decoding process and accelerate the decoding speed.

While the present invention has been described with respect to the particular embodiments, it will be apparent to those skilled in the art that various changes and modifications may be made without departing from the spirit and scope of the invention as defined in the following claims.

What is claimed is:

1. A method for communicating information bits, which comprises the steps of:
(a) inserting parity bits into the information bits to thereby output parity bit inserted information bits;
(b) encoding the parity bit inserted information bits to thereby produce an information bit stream to be transmitted;
(c) receiving the information bit stream;
(d) decoding the received information bit stream to thereby produce a decoded information bit stream;
(e) calculating parity bits corresponding to the information bit stream;
(f) detecting parity bits included in the decoded information bit stream;
(g) comparing the calculated parity bits with the detected parity bits included in the decoded information bit stream;
(h) if the detected parity bits are not identical to the calculated parity bits, repeating the steps (d), (f) and (g) as many times as a predetermined number of decoding times based on the decoded information bit stream; and
(i) if the detected parity bits are identical to the calculated parity bits, deleting the detected parity bits from the decoded information bit stream to thereby provide decoded information bits.

2. The method as recited in claim 1, wherein, in the step (a), an even or odd number of parity bits are periodically inserted into the information bits.

3. The method as recited in claim 1, wherein the step (b) includes the steps of:
(b1) encoding the parity bit inserted information bits to thereby generate first encoded information bits;
(b2) interleaving the parity bit inserted information bits to thereby produce interleaved information bits;
(b3) encoding the interleaved information bits to thereby provide second encoded information bits; and
(b4) outputting the information bit stream by multiplexing the parity bit inserted information bits, the first encoded information bits and the second encoded information bits.

4. The method as recited in claim 3, wherein the step (d) includes the steps of:
(d1) demultiplexing the received information bit stream to thereby produce an information part, a first parity part and a second parity part;
(d2) performing a decoding algorithm by using the information part and the first parity part to provide a first decoded information bit stream;
(d3) interleaving the first decoded information bit stream to generate an interleaved information bit stream;
(d4) performing the decoding algorithm by using the second parity part and the interleaved information bit stream to thereby output a second decoded information bit stream; and
(d5) deinterleaving the second decoded information bit stream to thereby provide the decoded information bit stream.

5. The method as recited in claim 4, wherein, if the decoded information bit stream is fed back thereto as a result of the step (h), the step (d2) performs the decoding algorithm by using the information part, the first parity part and the decoded information bit stream.

6. The method as recited in claim 5, wherein the decoding algorithm is a MAP (Maximum A Posteriori) decoding algorithm.

7. The method as recited in claim 1, wherein, if there are still differences between the calculated parity bits and the detected parity bits after the recursive decoding process has been repeated as many times as the predetermined number of decoding times, the step (h) further includes the steps of displaying errors in the decoded information bit stream and outputting the decoded information bits after deleting the detected parity bits included in the decoded information bit stream.

8. An apparatus for communicating information bits, which comprises:
a turbo encoder for inserting parity bits into the information bits and encoding the parity bit inserted information bits to thereby produce an information bit stream to be transmitted; and
a turbo decoder for recursively performing a decoding process for the information bit stream as many times as an adaptively determined number of decoding times to thereby output a decoded information bit stream, detecting parity bits included in the decoded information bit stream, and producing decoded information bits by deleting the detected parity bits from the decoded information bit stream after recursively performing the decoding process as many times as the adaptively determined number of decoding times, wherein the number of decoding times is determined by checking a state of the detected parity bits included in the decoded information bit stream.

9. The apparatus according to claim 8, wherein an even or odd number of parity bits are periodically inserted into the information bits.

10. The apparatus according to claim 8, wherein the turbo encoder includes:
means for inserting the parity bits into the information bits to thereby output the parity bit inserted information bits;
means for encoding the parity bit inserted information bits and generating first encoded information bits;
means for interleaving the parity bit inserted information bits so as to produce interleaved information bits;
means for encoding the interleaved information bits to thereby provide second encoded information bits; and
means for outputting the information bit stream by multiplexing the parity bit inserted information bits, the first encoded information bits and the second encoded information bits.

11. The apparatus according to claim 10, wherein the turbo decoder includes:
means for producing an information part, a first parity part and a second parity part by demultiplexing the information bit stream;
first decoding means for repeatedly performing a decoding algorithm based on the information part, the first parity part and extrinsic bits to thereby provide a first decoded information bit stream;
means for interleaving the first decoded information bit stream to generate an interleaved information bit stream;
second decoding means for recursively performing the decoding algorithm by using the second parity part and the interleaved information bit stream to thereby output a second decoded information bit stream;
means for deinterleaving the second decoded information bit stream so as to provide the decoded information bit stream;
parity bit checking means for calculating parity bits corresponding to the information bit stream, detecting the parity bits included in the decoded information bit stream, comparing the calculated parity bits with the detected parity bits included in the decoded information bit stream and, in response to the comparison result, outputting the decoded information bit stream as the extrinsic bits or generating a control signal; and
means for deleting, in response to the control signal, the detected parity bits from the decoded information bit stream and outputting the decoded information bits,
wherein the decoding process implemented by the first decoding means, the interleaving means, the second decoding means and the parity bit checking means is recursively performed until the control signal is generated.

12. The apparatus according to claim 11, wherein the parity bit checking means outputs the extrinsic bits if the detected parity bits are different from the calculated parity bits and, if otherwise, generates the control signal.

13. The apparatus according to claim 11, wherein the decoding algorithm is a MAP(Maximum A Posteriori) decoding algorithm.

14. The apparatus according to claim 11, wherein the number of decoding times is equal to or smaller than the predetermined number of times.

15. The apparatus according to claim 14, wherein, if there are still differences between the calculated parity bits and the detected parity bits after the recursive decoding process has been repeated as many times as the predetermined number of times, the turbo decoder terminates the decoding process and displays errors in the decoded information bit stream.
